(19) United States
(12) Patent Application Publication
(10) Pub. No.: US 2008/0159061 A1
(43) Pub. Date: Jul. 3, 2008

(54) Mixers and the Submersible Aerators With Using These Mixers

(76) Inventor: Sang bae Han, Gyeonggi-do (KR)

Correspondence Address: Royal W. Craig;Ober/Kaler, East Baltimore Street, Suite 800, Baltimore, MD, 21202, US

(21) Appl. No.: 11/884,078

(22) PCT Filed: Apr. 21, 2006
(86) PCT No.: PCT/KR06/01506

§ 371 Date: Aug. 9, 2007

(30) Foreign Application Priority Data
Feb. 20, 2006 (KR) 10-2006-0016462

(51) Int. Cl. B01F 3/04

(52) U.S. Cl. 366/102; 366/163.2

(57) ABSTRACT

The present invention relates to a mixing device and a submersible aerator using the mixing device, wherein the mixing device comprises: a mixer including a casing 3 mounted with an inlet weir 6 for sucking reactant, an inlet 4 and an outlet 5 and an impeller 1 disposed at an axle of a driving motor 2; a water current suction pipe 7 for communicating the inlet weir with the inlet of the casing; and a water current conveying pipe 11 where an ejector 12 is mounted at a deep-down region of a reactor, such that reactant can be mixed at a deep-down region of the reactor, and wherein the submersible aerator using the mixing device comprises at least one or more air supply means that include ejectors 10, 10a mounted with air supply pipes 21, 21a, an air chamber 25 mounted with blowing ports 26 and a vessel-type diffuser 9 mounted at one side of the impeller 1 inside the casing 3.

### TECHNICAL FIELD

The present invention relates to mixers and submersible aerators using these mixers, wherein the mixers are capable of performing water current circulating function in which reactant is absorbed at an upper shallow region of a reactor and is ejected at a deep region near to a floor of the reactor to cause water current to circulate, and submersible aerators are employed using the mixers.

### BACKGROUND ART

A typical conventional mixer has a disadvantage in that it is composed of simple impellers configured for being rotated in water by driving motors, such that reactant has not been evenly mixed in a reactor and mixing power has been disproportionately spread.

A typical aerator has an advantage of causing no secondary pollutions, such as noise and vibration and of excellent efficiency and easy operating control, but suffers from a number of shortcomings that make it inefficient, for example but not limited thereto, low power efficiency, generation of noise and vibration, and requirement of a large facility cost.

A typical brush aerator has a double function that includes an aerating function of disturbing the surface of a reactor to supply air and a mixing function, such that reactant is splashed, noise is generated, evaporation increases to lower the water temperature, and growth and activity of multiple nitrifying bacteria populations sensitive to temperature are degraded.

A diffuser aerator is typically disposed with a blower for supplying air to an aerobic tank, an air supply pipe and a diffuser, and suffers from a number of shortcomings that make it inefficient, for example but not limited thereto, exorbitant cost for facilities and power supply, complicated maintenance cost, generation of noise and vibration from the blower. A combined apparatus of a submersible aerator and a blower may also entail the same shortcomings.

A submersible aerator typically cannot generate a negative pressure strong enough for self-priming of air, such that it cannot be used in a deep reactor.

A typical ejector aerator has advantages of less dispersion of mist, silent operation, water temperature rise caused by generation of heat from a motor and intermittent aerating function by an automatic valve. However, there is a disadvantage of decreased efficiency of aerating power because volume-expanded air has to be sucked into a deep region using a negative pressure lower than an atmospheric pressure that is generated from inside an ejector when pressure decreases.

### DISCLOSURE

### Technical Problem

The present invention is disclosed to solve the aforementioned problems and it is an object of the present invention to provide a mixer disposed with a water current circulation function and capable of fully mixing reactant in a deep reactor, and to provide a submersible aerator combining air supply means such as a diffuser, a brush aerator and an ejector using the mixer for being capable of in-depth aeration and excellent and economical aeration efficiency.

### Technical Solution

In accordance with the object of the present invention, there is provided a mixer, the mixer disposed with a casing equipped with an inlet and an outlet, an impeller mounted inside the casing and a driving motor for rotating the impeller and capable of pumping function, the mixer comprises: a first mixing unit upwardly mounted at the inlet of the casing with a water current suction pipe equipped thereon with an inlet weir; a second mixing unit mounted at the outlet of the casing with a water current discharge pipe equipped with a vent; and a third mixing unit disposed with a water current suction pipe mounted with inlet weirs each at the inlet and the outlet of the casing, and with a water current discharge pipe mounted with a vent.

Now, hereinafter, an operation process of the mixing units will be described.

First, the first mixing unit is such that the inlet disposed in deep water is mounted with the water current suction pipe disposed with the inlet weir, and when the impeller is rotated by the driving motor, reactant is sucked via the inlet weir by the suction force generated from the inlet of the casing, and the reactant sequentially flows through the water current suction pipe, the inlet of the casing, an inside of the casing and the impeller to be ejected from deep water on the lower region of the reactor via the outlet of the casing. In other words, the reactant above is fed to a lower side of the reactor through the water current suction pipe and the mixer, and is directly ejected to the outlet of the casing in the mixer to be mixed with reactant and circulated upwards, such that a smooth mixing (stirring) in the reactor can be performed.

However, the mixing power efficiency may decrease, because the mixer is installed on a floor of a deep reactor, and water current is largely transported by suction head (rated suction) of the mixer from the inlet weir at a shallow region to a deep region where head requirement is great.

The second mixing unit is designed to improve the inefficiency of the first mixing unit. The second mixing unit is such that an inlet of the casing is directly connected to an inlet weir for minimizing the suction head of the mixer, and an outlet of the casing is mounted with a water current conveying pipe disposed with an ejector, where the ejector of the water current conveying pipe is installed at a deep region of the reactor. The reactant introduced via the inlet weir sequentially passes the inlet of the casing, an inside of the casing, an impeller, the outlet of the casing and the water current conveying pipe to be ejected to a lower region of the reactor via the ejector disposed at a distal end of the water current conveying pipe.

The second mixing unit may enhance the mixing power efficiency, because suction head of the mixer has been minimized and discharge head (rated discharge) of high efficiency is used for water current circulation in the reactor.

The third mixing unit is disposed with a water current suction pipe mounted with inlet weirs each at the inlet and the outlet of the casing, and with a water current discharge pipe mounted with a vent, where the inlet weir is installed at a shallow region of a reactor while an outlet of the water current conveying pipe is installed at a deep region. The third mixing unit may be an intermediate version between the first mixing unit and the second mixing unit, such that the suction head and the discharge head are efficiently combined, thereby enabling to smoothen the water current circulation and mixing even in the deep reactor and to improve the mixing power efficiency.

The inlet weir installed at the first, second and third mixing units may come in various shapes, e.g., a cylindrical shape and a morning glory shape, etc.

Various types of air supply means may be installed at the first mixing unit for sucking and feeding the reactant in response to the suction head, the second mixing unit for feeding the reactant according to the discharge head, and the third mixing unit for sucking and feeding the reactant by evenly arranging the suction head and the discharge head, such that an excellent submersible aerator which is smooth in air supply and has an excellent power efficiency can be installed in a deep reactor.

The air supply means is comprised of a double pipe for dispersing the air pumped from a blower to the inlet weir of the mixer or water current suction pipe in minuscule air bubbles, where an inner pipe is a porous pipe formed with blowing ports or a diffuser formed with micro pores.

Furthermore, the air supply means may be a brush aerator installed at an inlet weir side of the mixer, an impeller for rotating and generating minuscule air bubbles by being partially exposed to the air and balance part submerged in the water, or a submergible aerator installed at a hollow shaft thereof with an axial impeller for installing a brush aerator of air self-priming type at an inlet weir side of the mixer.

Still furthermore, the air supply means may be an air chamber installed with a plurality of blowers about an impeller of the mixer for supplying air, or an air chamber with its casing formed with a blower, and when external air is pumped in by associating the blower with a discharge outlet via a flue, the air erupted via the flue inside the air chamber may be dispersed in minuscule air bubbles by the water current generated by the impeller and widely distributed to an inside the reactor. The air chamber may be formed with micro pores to allow the air chamber itself to become a disperser.

The air supply means may be a cylindrical diffuser of a cylindrical type with its inside hollowed and any one side being opened, or a cylindrical type with its cone removed. The diffuser communicates with an outlet of a blower via a flue, and the air supplied through the diffuser is dispersed in minuscule air foams by the water current generated by the impeller and widely dispersed into the reactor.

The air supply means may be comprised of a supply pipe for sucking air from the atmosphere via the inlet weir or the water current suction pipe an ejector disposed with a nozzle, and may be limitlessly selected from a standard type or an annular type.

The air supply means disposed at the ejector may be installed with flow path control means, e.g., an automatic valve for selective operation of the reactor as an aeration mixing or a non-aeration mixing by using the air supply means disposed at the ejector, or for intermittent operation in which alternative repetition is performed according to a period where aeration mixing or non-aeration mixing is established.

However, the intermittent aeration method by the flow path control means disposed at the air supply pipe disadvantageously increases a head loss because water current flows in through the ejector where head loss is great even during the non-aeration mixing where air supply is not necessary.

As a result, the water current suction pipe is additionally disposed with a bypass flow path through which reactant can be bypassed and flow path control means, where the flow path control means is comprised of an intermittent aeration system which opens and shuts in association with a timer, a DO (Dissolved Oxygen) controller and an ORP (Oxidation-Reduction Potential) controller to thereby enable to prevent head loss caused by the ejector even during the non-aeration mixing.

The air supply pipe is disposed with flow path control means, e.g., a valve for controlling the amount of air introduced into the ejector. An air amount control method for controlling an openness of the valve is such that an air speed introduced varies in response to the openness of the valve to make it difficult to control the air amount.

Therefore, the amount of flow that is introduced by bypassing the water current suction pipe or the outlet of the casing instead of passing through the ejector can be controlled by controlling the openness of the flow path control means composed of the valve disposed at a bypass flow path, thereby enabling to control the air inflow amount of the ejector precisely, and an increase of bypass flow amount can stop air suction at the ejector to enable to maintain the water current circulation amount even during the operation under the non-aeration mixing condition.

An air supply pipe at the ejector is connected with an odor inflow pipe for sucking odor discharged from odor generating sources such as a concentration tank and a dehumidifier, and air containing odor is sucked into the reactor to allow deodorizing the odor by biologically decomposing the odorous material by way of microorganisms growing in the reactor.

Furthermore, the air supply pipe of the ejector for sucking the air is made to communicate with the outlet of the blower, and the air of the blower is fed to the ejector by the blower to increase an aeration capacity of the submersible aerator applied by the ejector.

Air bubbles move downward through the water current suction pipe or the water current conveying pipe and collide to band together as coarse bubbles. The coarse bubbles increase in floating speed thereof such that there occurs a surging or a flow pulsation in which air suction amount abruptly and periodically decreases because the coarse bubbles float toward the inlet weir to overflow outside if floating speed of the coarse bubbles become greater than travel speed of the water current.

In order to prevent this phenomenon, the water current suction pipe and the water current conveying pipe are installed with eddy current prevention means, e.g., a reducer, a throat and a line mixer to finely disperse the air bubbles generated by the eddy current, whereby the generation of the coarse bubbles are restrained to stably maintain the aeration efficiency.

When the air supply means thus described is combined with the first, second and third mixing units to form an aerator, air with less specific gravity is supplied deep into the inlet weir or water current suction pipe. Then the air supplied to the inlet of the casing or an uppermost layer of the water current suction pipe becomes faster than the floating speed of the air bubbles formed by the suction force of the mixer and non-compressive. The air is forcibly fed deep into the reactor by the flow of the specific gravity-great reactant to be ejected through the outlet of the mixer or ejecting ports of the water current conveying pipe to thereby enable to aerate the deep reactor. The present invention has an advantage over the conventional aerators for pumping the air with a high pressure to a diffuser or an aerator disposed in a deep reactor in that less power consumption is consumed and a deep aeration is possible.

### Advantageous Effect

The present invention can provide a mixer capable of full mixture by water current circulation even in a deep reactor, and using the aerator, efficiency of the conventional aerators can be improved or air can be supplied to a deep inside of the reactor, thereby enhancing aeration and mixing efficiency and embodying an economic aeration device.

### DESCRIPTION OF DRAWINGS

FIG. 1 is a conceptual rendition of a mixer according to a first exemplary embodiment of the present invention.

FIG. 2 is a conceptual rendition of a mixer according to a second exemplary embodiment of the present invention.

FIG. 3 is a conceptual rendition of a mixer according to a third exemplary embodiment of the present invention.

FIG. 4 is a conceptual rendition of a submersible aerator using an aerator according to a first exemplary embodiment of the present invention.

FIG. 5 is a conceptual rendition of a submersible aerator using an aerator according to a second exemplary embodiment of the present invention.

FIG. 6 is a conceptual rendition of a submersible aerator using an aerator according to a third exemplary embodiment of the present invention.

FIG. 7 is a conceptual rendition of a submersible aerator using an aerator according to a fourth exemplary embodiment of the present invention.

FIG. 8 is a conceptual rendition of a submersible aerator using an aerator according to a fifth exemplary embodiment of the present invention.

FIG. 9 is a conceptual rendition of a submersible aerator using an aerator according to a sixth exemplary embodiment of the present invention.

FIG. 10 is a conceptual rendition of a submersible aerator using an aerator according to a seventh exemplary embodiment of the present invention.

FIG. 11 is a conceptual rendition of a submersible aerator using an aerator according to an eighth exemplary embodiment of the present invention.

FIG. 12 is a conceptual rendition of a submersible aerator using an aerator according to a ninth exemplary embodiment of the present invention.

FIG. 13 is a conceptual rendition of a submersible aerator using an aerator according to a tenth exemplary embodiment of the present invention.

### BEST MODE

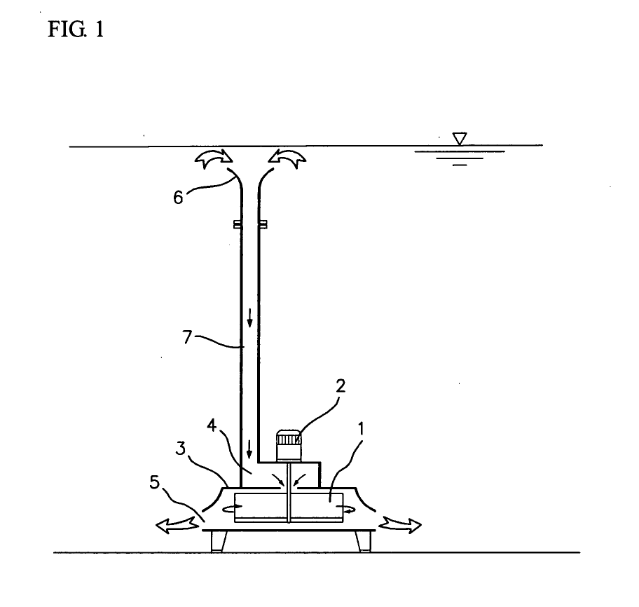

FIG. 1 is a conceptual rendition of a mixer according to a first exemplary embodiment of the present invention.

The mixer includes a casing comprised of one or more inlets 4 and one or more ejecting ports 5, an impeller 1 disposed inside the casing and a driving motor 2 for rotating the impeller 1. An inlet 4 of the casing of a mixer disposed in a deep reactor capable of pumping function is connected to a water current suction pipe 7, and a distal end of the water current suction pipe 7 is disposed with an inlet weir 6 installed at a relatively shallow region of the reactor for sucking reactant at an upper layer thereof.

The reactant introduced through the inlet weir 6 sequentially passes the inlet weir 6, the water current suction pipe 7, the inlet 4 of the casing, inside of the casing, the impeller 1 and the outlet 5 of the casing to be ejected deep into the reactor. The ejected reactant is mixed with reactant in the reactor by the stirring power of the ejected water current to be lifted upwards, such that the reactant can circulate in the entire area of the reactor for full mixing. The water current circulation is performed mostly by the suction head of the mixer.

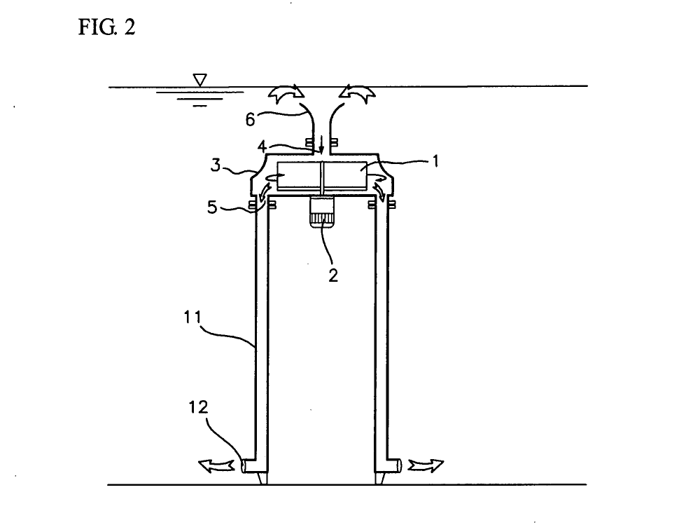

FIG. 2 is a conceptual rendition of a mixer according to a second exemplary embodiment of the present invention.

The inlet 4 of the casing of the mixer is directly connected to the inlet weir 6, the outlet 5 of the casing is disposed with a water current conveying pipe 11 mounted with ejection ports 12, and the ejecting ports 12 are extensively connected with the water current conveying pipe 11 to being located in a deep region.

The reactant sucked in through the inlet weir 6 sequentially passes the inlet weir 6, the water current suction pipe 7, the inlet 4 of the casing, inside of the casing, the impeller 1 and the outlet 5 of the casing to be ejected deep into the reactor through the ejecting ports 12. The ejected reactant is mixed with reactant in the reactor by the stirring power of the ejected water current to be lifted upwards, such that the reactant can circulate in the entire area of the reactor for full mixing. The water current circulation is done mostly by the suction head of the mixer.

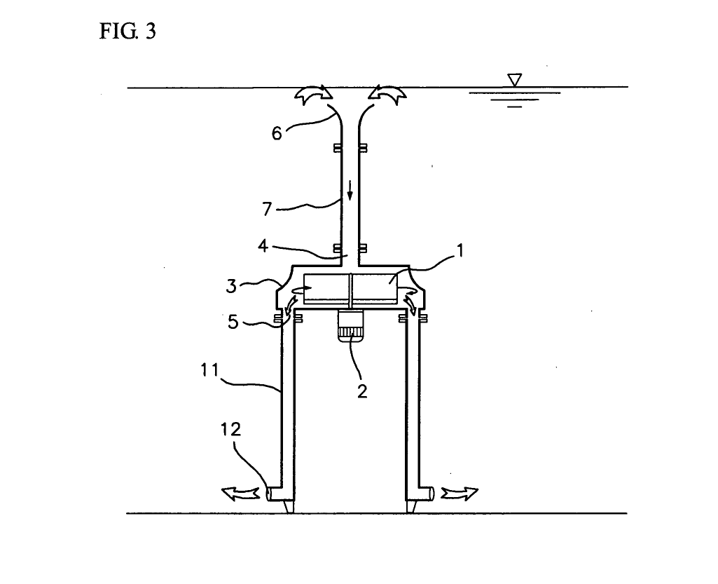

FIG. 3 is a conceptual rendition of a mixer according to a third exemplary embodiment of the present invention.

In the present exemplary implementation, the mixer is disposed with the water current suction pipe 7 and the water current conveying pipe 11 to form a water current circulation, such that suction head and the discharge suction can be effectively distributed.

The inlet 4 of the mixer is installed with the water current suction pipe 7 mounted with the inlet weir 6, and the outlet 5 of the mixer is formed with one or more water current conveying pipes 11 to allow the ejecting ports 12 to be situated near at a deep-down floor of the reactor, such that the water current is sucked in and fed up to a predetermined depth, and for the remaining depth, the sucked-in water current is pumped to be fed into a deep-down region of the reactor, whereby the suction head and the discharge head of the mixer can be effectively combined to enable smooth water current circulation and mixing even in a deep-down area of the reactor and improved power efficiency.

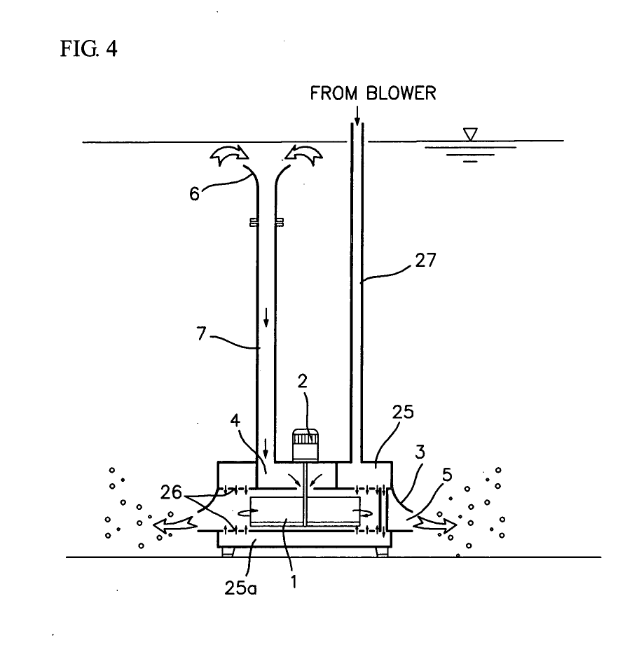

FIG. 4 is a conceptual rendition of a submersible aerator using an aerator according to a first exemplary embodiment of the present invention with reference to FIG. 1.

The present exemplary implementation relates to a submersible aerator configured to form air supply means by air chambers 25, 25a disposed with micro pores or blowing ports 26 for dispersing the air supplied from a blower via a mixer and a flue 27 according to the first embodiment of the present invention with reference to FIG. 1.

The casing 3 of the mixer is disposed with air chambers 25, 25a formed with a plurality of blowing pores 26 for generating minuscule air bubbles, or the casing itself is formed with an air chamber mounted with blowing pores, and the air chamber is communicated therein by an outlet of the a blower (not shown) and the flue 27.

When air is pumped by a blower, the air that has passed the flue 27 and the air chambers 25, 25a is ejected through the blowing ports 26, and is dispersed to minuscule air bubbles by the water current generated by the impeller 1 and widely dispersed inside the reactor. At this time, the air chambers 25, 25a may be disposed either at an upper side of the impeller 1 or a lower side, or may be disposed at both sides. The air chambers 25, 25a themselves may be formed with micro pores to serve as diffusers.

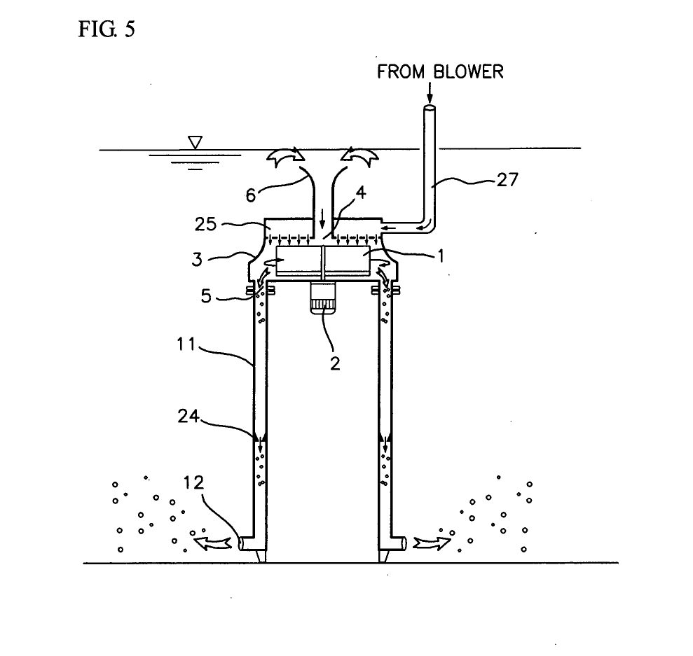

FIG. 5 is a conceptual rendition of a submersible aerator using an aerator according to a second exemplary embodiment of the present invention.

The present exemplary implementation relates to a submersible aerator configured to form air supply means by air chambers 25, 25a disposed with micro pores or blowing ports 26 for dispersing the air supplied from a blower via a mixer and a flue 27 according to the second embodiment of the present invention of FIG. 2, where the inlet weir 6 is directly connected to the inlet 4 of the casing 3 at the mixer. Other configuration and operation are the same as those of the submersible aerator according to the first embodiment with reference to FIG. 4.

As in the submersible aerators of the first and second embodiments with reference to FIGS. 4 and 5, the air supply means may be combined by the mixer and air chambers 25, 25a according to the third embodiment of FIG. 3 to thereby form a submersible aerator.

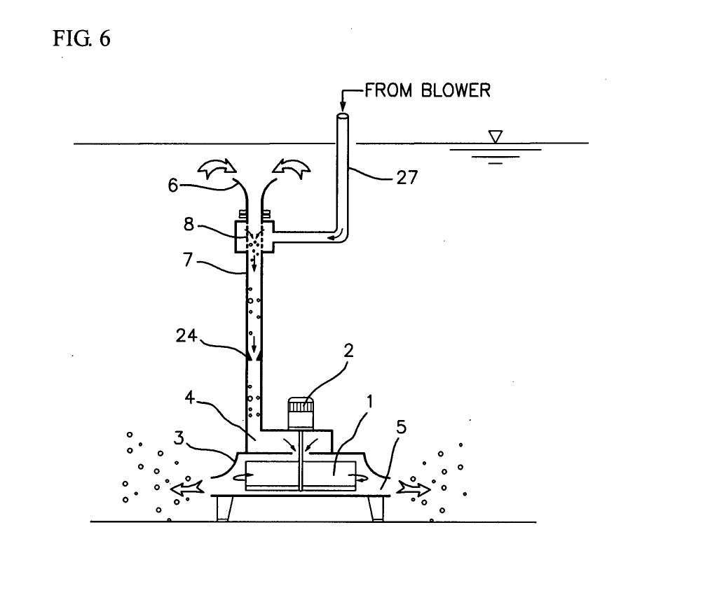

FIG. 6 is a conceptual rendition of a submersible aerator using an aerator according to a third exemplary embodiment of the present invention.

The present exemplary implementation relates to a submersible aerator configured to form air supply means by the diffuser 8 for dispersing the air supplied from a blower via a mixer and a flue 27 in minuscule air bubbles according to the first embodiment of the present invention with reference to FIG. 1.

The inlet weir 6 side or an upper side of the water current suction pipe 7 installed at a shallow region of the reactor is disposed with air supply means formed by a diffuser 8 formed with micro pores for dispersing to minuscule air bubbles the air pumped from the blower via the flue 27 to thereby generate minuscule air bubbles, and when pressure becomes low, volume expands to cause specific gravity-low air to be supplied to a shallow region inside the water current suction pipe 7 by the diffuser 8, and the air supplied deep into the water current suction pipe 7 uses the flow of reactant, which is faster than a floating speed of the air bubbles formed by the suction force of the mixer, non-compressive and has a larger specific gravity, to be forcibly transported to a deep lower region of the reactor and ejected through the outlet 5 of the mixer, thereby mixing and aerating the reactor.

The air bubbles moves downward through the water current suction pipe 7 and the water current conveying pipe 11 to allow the minuscule air bubbles to collide and be united as coarse air bubbles, whereby the air bubbles increase in floating speed thereof. The coarse air bubbles rise upward toward the inlet 4 side and backflow when the rising speed becomes greater than travel speed of the water current. In order to prevent this phenomenon, the water current suction pipe 7 and the water current conveying pipe 11 are installed with eddy current prevention means 24, e.g., a reducer, a throat and a line mixer to finely disperse the air bubbles caused by the eddy current, whereby the generation of the coarse bubbles are restrained to stably maintain the aeration efficiency.

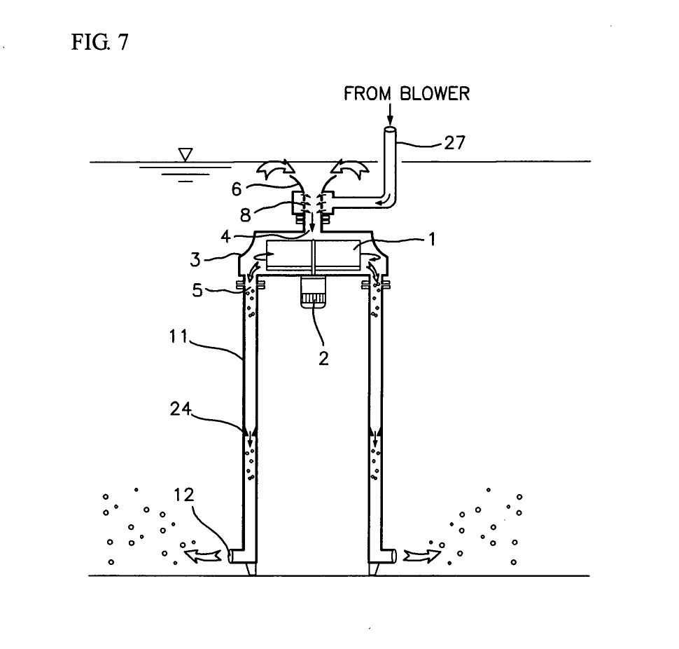

FIG. 7 is a conceptual rendition of a submersible aerator using an aerator according to a fourth exemplary embodiment of the present invention.

The present exemplary implementation relates to a submersible aerator configured to form air supply means by the diffuser 8 for dispersing the air supplied from a blower via a mixer and a flue 27 in minuscule air bubbles according to the second embodiment of the present invention of FIG. 2, where the inlet weir 6 is directly connected to the inlet 4 of the casing 3 at the mixer. Other configuration and operation are the same as those of the submersible aerator according to the third embodiment with reference to FIG. 6.

As in the submersible aerators of the third and fourth embodiments with reference to FIGS. 6 and 7, the air supply means may be combined by the mixer and the diffuser 8 according to the third embodiment of FIG. 3 to thereby form a submersible aerator.

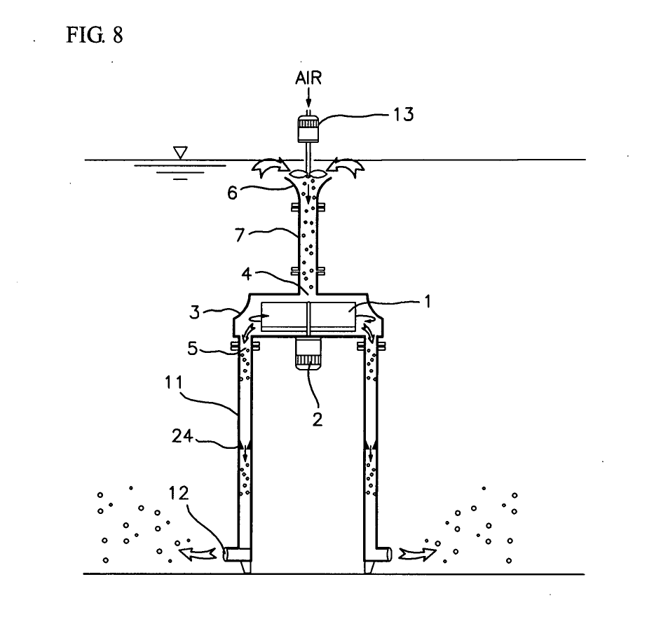

FIG. 8 is a conceptual rendition of a submersible aerator using an aerator according to a fifth exemplary embodiment of the present invention.

The present exemplary implementation relates to a submersible aerator configured to combine a brush aerator 9 and a mixer disposed with the water current suction pipe 7 and the water current supply pipe 11 according to the third embodiment of the present invention with reference to FIG. 3.

The air supply means is an axial impeller, part of which is exposed to the air at the inlet weir 6 side of the mixer and balance of which is submerged and rotated in the water, or a submergible aerator 9 of air self-priming type.

The minuscule air bubbles generated by the brush aerator 9 move downward along with the water current to pass through the water current suction pipe 7, the inlet 4 of the casing 3, the inside of the casing 3, the impeller 1, the outlet 5 of the casing 3 and the water current conveying pipe 11 via the inlet weir 6, and is ejected to the reactor via the ejecting ports 12 mounted deep down inside the reactor.

The air supply means configured by the brush aerator 9 may be combined with the mixer of the first embodiment with reference to FIG. 1 and the second embodiment with reference to FIG. 2 to form a submersible aerator.

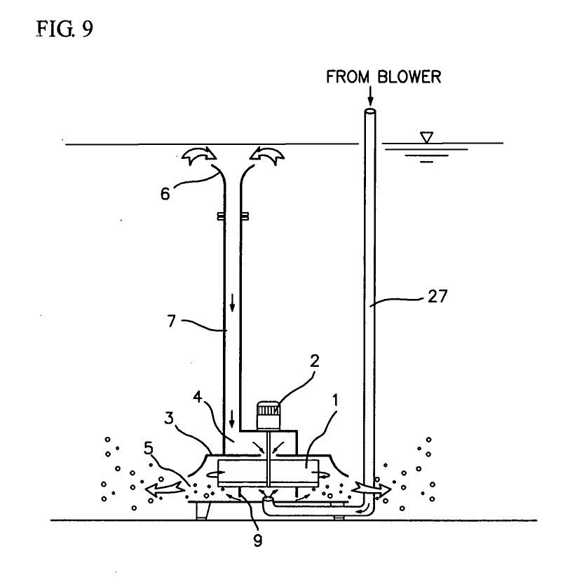

FIG. 9 is a conceptual rendition of a submersible aerator using an aerator according to a sixth exemplary embodiment of the present invention.

The present exemplary implementation is a submersible aerator comprised of air supply means combined by a mixer according to the first embodiment with reference to FIG. 1 and a diffuser 9 of a cylindrical type with its inside hollowed and any one side being opened or a cylindrical type with its cone removed. The diffuser 9 communicates with an outlet of a blower via a flue, and the air supplied through the diffuser 9 is ejected from an open port of the diffuser 9 and dispersed in minuscule air foams by the water current generated by the impeller and widely dispersed into the reactor.

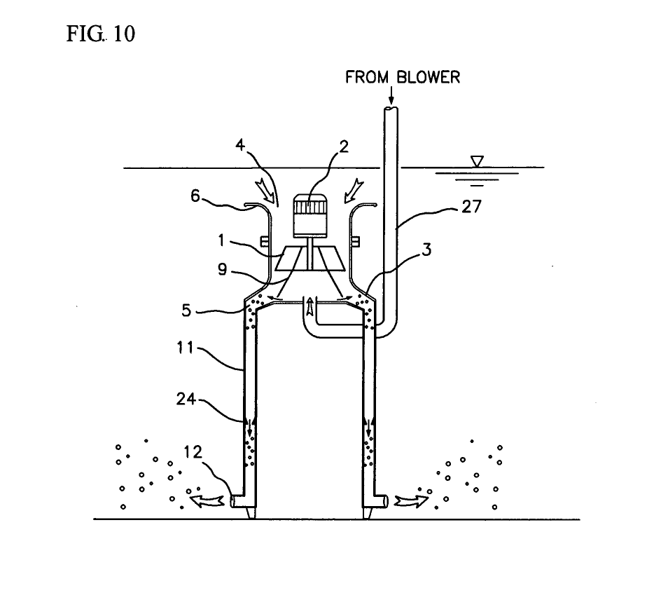

FIG. 10 is a conceptual rendition of a submersible aerator using an aerator according to a seventh exemplary embodiment of the present invention.

The present implementation is a submersible aerator where air supply means is disposed with the vessel-typed diffuser 9 at the mixer according to the second embodiment with reference to FIG. 2.

As noted in the submersible aerators according to the sixth and seventh embodiments with reference to FIGS. 9 and 10, a submersible aerator may be formed by combining the vessel-typed diffuser 9 with the mixer of the third embodiment with reference to FIG. 3.

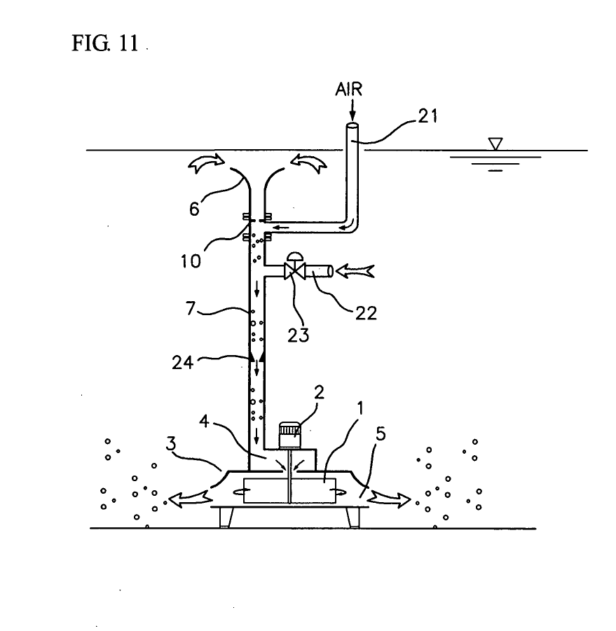

FIG. 11 is a conceptual rendition of a submersible aerator using an aerator according to an eighth exemplary embodiment of the present invention.

The present implementation relates to a submersible aerator configured by combining the mixer according to the first embodiment with reference to FIG. 1 with air supply means formed by an ejector 10 disposed with a nozzle mounted at an upper layer of the water current suction pipe 7 and an air supply pipe 21. Although a standard ejector 10 is exemplified in the present implementation, an annular ejector may be limitlessly employed where an air supply pipe is inserted into an inlet weir. The blower and the brush aerator may produce noise and vibration, but the ejector is an environmentally-friendly device as its operation is performed noiselessly and silently.

The water current suction pipe 7 may be formed with a bypass flow path 22 into which reactant can be introduced, such that the reactor can be selectively operated either in aerating mixing (stirring) or non-aerating mixing method, or in intermittent aeration where the aerating mixing or the non-aerating mixing are alternatively repeated in response to a predetermined period to thereby control the introduced flow amount and an aerated amount.

Furthermore, if an odorous air inflow pipe (not shown) is connected to an inlet of the air supply pipe 21 for sucking odorous air discharged from an odor generating source, the odor sucked into the reactor can be effectively and economically removed by microorganisms growing in the reactor.

The air supply pipe 21 is disposed with a flue communicating with the outlet of the blower, and the air is pumped to further increase an aeration capacity compared with that of self-priming method by way of ejector.

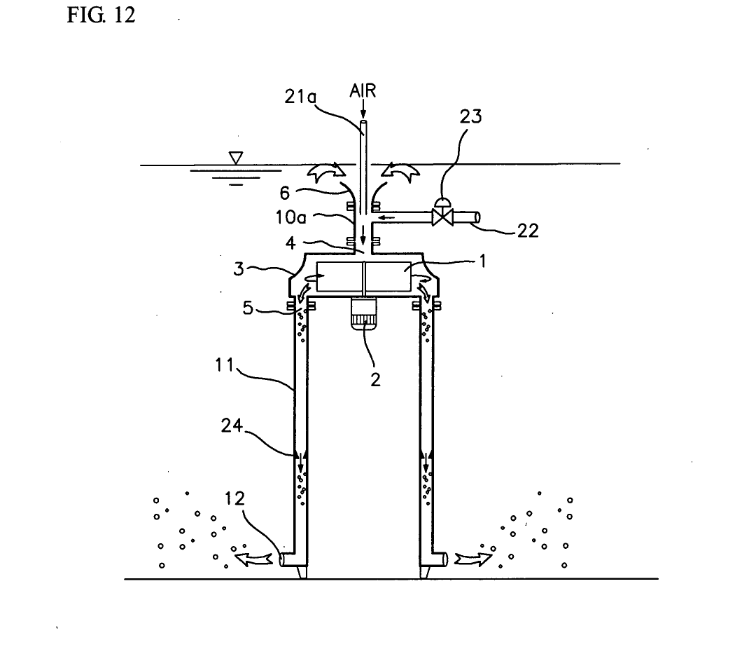

FIG. 12 is a conceptual rendition of a submersible aerator using an aerator according to a ninth exemplary embodiment of the present invention.

The present implementation relates to a submersible aerator comprised of air supply means by an annular type ejector 10a configured by insertion of an air supply pipe 21a into the inlet weir 6 and the mixer according to the second embodiment with reference to FIG. 2. Although an annular type ejector 10a 10 is exemplified in the present implementation, a standard ejector may be limitlessly employed, and other configuration and operation are the same as those of the eighth embodiment.

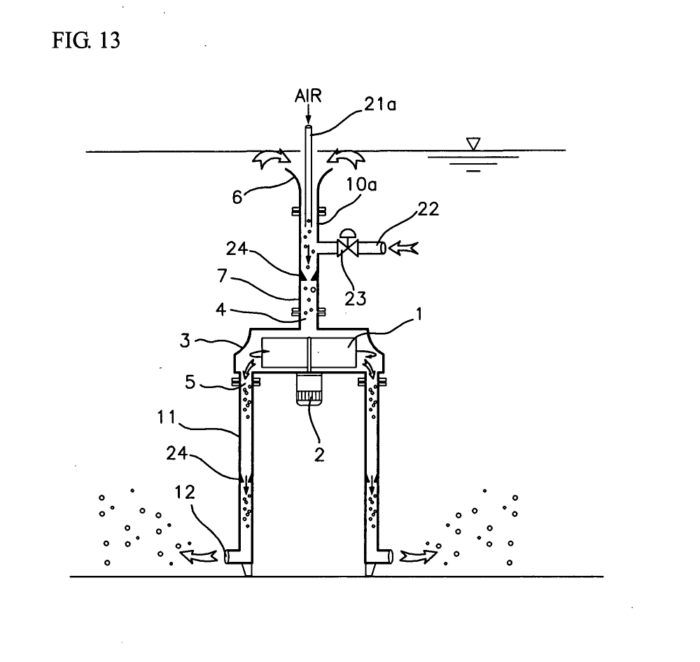

FIG. 13 relates to a submersible aerator comprised of air supply means configured by the mixer according to the third embodiment with reference to FIG. 3 and an annular ejector 10a constructed by insertion of air supply pipe 21 into the inlet weir 6.

Although an annular type ejector 10a 10 is exemplified in the present implementation, a standard type ejector may be limitlessly employed, and other configuration and operation are the same as those of the eighth embodiment with reference to FIG. 11.

It should be noted that an aeration capacity is limited by a capacity of the mixer because the water current and air transport amount in the submersible aerators according to the third, fourth, fifth, eighth, ninth and tenth embodiments with reference to FIGS. 6, 7, 8, 11, 12 and 13 are largely dependent on the water current transport capacity of the mixers.

As a result, the aeration capacity of the submersible aerators determined by and based on the aeration capacity of the mixer consumed by the reactor may be satisfied even in a state where an appropriate stirring power necessary for the reactor is maintained by additionally supplying air by a blower via the flue 27 and by additionally configuring air chambers 25, 25a mounted with blowing ports 26 and a vessel-type diffuser 9 because amount of dissolved oxygen is insufficient in an actual reactor if an inflow load is of a high concentration.

While only selected implementations have been chosen to illustrate the present invention, it will be apparent to those skilled in the art from this disclosure that various changes and modifications can be made herein without departing from the scope of the invention as defined in the appended claims. Furthermore, the foregoing descriptions of the implementations according to the present invention are provided for illustration only, and not for the purpose of limiting the invention as defined by the appended claims and their equivalents. Thus, the scope of the invention is not limited to the disclosed implementations.

1. A mixing device comprising: an inlet weir 6 for sucking reactant; a mixer disposed with a casing 3 mounted with an inlet 4 and an outlet 5, an impeller 1 mounted inside the casing 3, and a driving motor 2 for rotating the impeller 1 and having a pumping function; and a water current suction pipe 11 for communicating the inlet weir 6 with the inlet 4 of the casing 3 such that the reactant sucked through the inlet weir 6 can sequentially pass the inlet 4 of the casing 3, an inside of the casing 3 and the impeller 1 to be transported deep down into a reactor and to be ejected through the outlet 4 of the casing 3.

2. A submersible aerator using the mixing device of claim 1, wherein the device is mounted with air supply means communicating with an inside of the casing 3, and air which is a compressed fluid supplied through the air supply means and having a low specific gravity is ejected via the outlet of the casing 3 from a deep-under region of the reactor by flow of reactanct which has a high specific gravity, is non-compressive and faster in floating speed that that of air bubbles formed by suction head of the mixer through the outlet 5 of the casing 3 via the inlet weir 6, the water current suction pipe 7, the inlet 4 of the casing 3, the inside of the casing 3 and the impeller 1 to thereby aerate and mix the reactor.

3. A mixing device comprising: an inlet weir 6 for sucking reactant; a mixer disposed with a casing 3 mounted with an inlet 4 and an outlet 5, an impeller 1 mounted inside the casing 3, and a driving motor 2 for rotating the impeller 1 and having a pumping function; and a water current conveying pipe 11 disposed at the outlet 5 of the casing 3 and having an ejector 12 mounted at a deep-under region of the reactor such that the reactant sucked through the inlet weir 6 can sequentially pass the inlet 4 of the casing 3, an inside of the casing 3, the impeller 1 and the outlet 5 of the casing 3 to be pumped and ejected deep down into a reactor.

4. The mixing device as claimed in claim 3 further comprising a water current suction pipe 7 for communicating the inlet weir 6 with the inlet 4 of the casing 3.

5. A submersible aerator using the mixing device of claim 3, wherein the device is mounted with air supply means communicating with an inside of the casing 3, and air which is a compressed fluid supplied through the air supply means and having a low specific gravity is ejected via ejecting ports 12 from a deep-under region of the reactor by flow of reactant which has a high specific gravity, is non-compressive and faster in floating speed that that of air bubbles formed by suction head of the mixer through the inside of the casing 3, the impeller 1, the outlet 5 of the casing 3 and the water current conveying pipe 11 to thereby aerate and mix the reactor.

6. The submersible aerator using the mixing device as claimed in claim 2 or 5, wherein the water current suction pipe 7 is disposed with eddy current generating means 24 such as a reducer, a throat and a line mixer for generating eddy current to allow coarse air bubbles to be dispersed in minuscule air bubbles.

7. The submersible aerator using the mixing device as claimed in claim 2 or 5, wherein the air supply means defines air chambers 25, 25a mounted with micro pores or blowing pores 26 for dispersing air supplied from a blower through a flue 27.

8. The submersible aerator using the mixing device as claimed in claim 2 or 5, wherein the air supply means is a diffuser 8 formed with minuscule air pores for dispersing air supplied from a blower through a flue 27.

9. The submersible aerator using the mixing device as claimed in claim 2 or 5, wherein the air supply means is a brush aerator 13.

10. The submersible aerator using the mixing device as claimed in claim 2 or 5, wherein the air supply means is a vessel-type aerator 9 for dispersing the air supplied from a blower via the flue 27 by the water current generated by the impeller 1 in minuscule air bubbles.

11. The submersible aerator using the mixing device as claimed in claim 2 or 5, wherein the air supply means is ejectors 10, 10a mounted with air supply pipes 21, 21a for sucking in air from the atmosphere.

12. The submersible aerator using the mixing device as claimed in claim 2 or 5, comprising a bypass flow path 22 mounted with a flow path control means 24 interposed between the ejectors 10, 10a and the inlet 5 of the casing for controlling the amount of air sucked in from the ejectors 10, 10a and for being operated by selecting the reactor in either aerating mixing (stirring) or non-aerating mixing, or for being operated in intermittent aeration where aerating mixing or non-aerating mixing is alternatively repeated.

13. The submersible aerator using the mixing device as claimed in claim 2 or 5, wherein the air supply pipes 21, 21a are selectively mounted with either an odor air inflow pipe for sucking odor containing air discharged from odor generating sources such as a concentration tank and a dehumidifier, or a flue into which air is pumped from a blower.
